(19) United States
(12) Patent Application Publication
(10) Pub. No.: US 2008/0283099 A1
(43) Pub. Date: Nov. 20, 2008

(54) ENERGY-OPTIMIZED CLEANING MACHINE

(76) Inventors: Thomas Peukert, Oberkirch (DE); Bruno Gaus, Offenburg (DE); Joachim Kupetz, Berghaupten (DE)

Correspondence Address: Muncy, Geissler, Olds & Lowe, PLLC, P.O. BOX 1364, FAIRFAX, VA, 22038-1364, US

(21) Appl. No.: 12/054,155

(22) Filed: Mar. 24, 2008

Related U.S. Application Data
(60) Provisional application No. 60/938,143, filed on May 15, 2007.

(30) Foreign Application Priority Data
Mar. 22, 2007 (DE) 10 2007 013 813.1

(51) Int. Cl. B08B 3/04

(52) U.S. Cl. 134/99.1; 134/105

(57) ABSTRACT

A cleaning machine is provided, in particular a single-chamber dishwashing machine, that includes a washing chamber for accommodating items to be cleaned or washed. At least one wash arm with a number of spray nozzles is located in the washing chamber. A waste-water line into which waste water is pumped runs from the washing chamber. Exhaust air from the washing chamber is conducted into the waste-water line via an exhaust-air line, with the washing chamber being bounded by at least one wall which stores a heat-exchanger fluid or through which heat-exchanger fluid flows.

This nonprovisional application claims priority to German Patent Application No. DE 10 2007 013 813.1, which was filed in Germany on Mar. 22, 2007, and to U.S. Provisional Application No. 60/938,143, which was filed on May 15, 2007, and which are both herein incorporated by reference.

### BACKGROUND OF THE INVENTION

1. Field of the Invention

The present invention relates to an energy-optimized cleaning machine, in particular an energy-optimized single-chamber dishwashing machine.

2. Description of the Background Art

Single-chamber cleaning machines of this type are used, for example, in the catering industry, in the hotel industry, in bakeries, hospitals and care homes and the like. The cleaning machine proposed according to the invention may be in the form of a front-loader or a conveyor-type cleaning machine. These are used particularly for cleaning hollowware, glasses, flatware, containers etc. which have been used for communal purposes and are to be cleaned.

Conventional cleaning machines usually have a washing chamber and a washing-water tank. A circulation pump draws washing water from the washing tank and sprays it onto the soiled items being cleaned by means of wash arms which are fixed in the washing chamber and can have spray nozzles. The sprayed washing water falls back into the washing-water tank via a base collection device and is again drawn in by the circulation pump and sprayed onto the items being cleaned. In customary commercial cleaning machines, the items being cleaned are subjected to final-washing by the washing water from the washing-water tank after said items have been cleaned. During the final-washing, the items being cleaned are usually sprayed with hot final-washing water or fresh water by means of a further spraying system. The introduction of hot final-washing water into the washing chamber heats up the chamber and the items being cleaned, with the washing chamber filling up with vapor (steam). In commercial cleaning machines, the items which have been cleaned are usually removed from the cleaning machine at the end of the program in order to dry by virtue of their inherent heat.

If the washing chamber is then opened by the operator, the hot water vapor flows out of the washing chamber into the surrounding area in the room. Therefore, when the door of the washing chamber is opened, moisture unnecessarily enters the room in which the cleaning machine is installed. Furthermore, it is not readily possible for the operator to immediately remove the items which have been cleaned from the washing chamber, without being exposed to the risk of burning himself. It is generally necessary to wait for a certain period of time until the heated items which have been cleaned are cooled and dried by virtue of the cooler, relatively dry ambient air.

DE 10 2005 023 429 A1 discloses a method in which cooler water is sprayed into the washing chamber after the final-washing step, and the items which have been washed are cooled in this way. Furthermore, the water vapor in the washing chamber is condensed by the water which is sprayed in. However, one disadvantage of this is that the water from the reservoir tank may be contaminated with germs and there is therefore a risk of back-contamination after the items which have been washed free of germs are cleaned. Furthermore, the application of water after the final-washing step makes self-drying of the heated items which have been cleaned more difficult.

DE 10 2005 023 428 A1 discloses a commercial dishwasher in which an air stream is generated in the washing chamber by means of a fan after final-washing. The fan draws in ambient air via an air inflow which is provided below the door, said ambient air flowing through the washing chamber which is filled with water vapor and contains the items which have been washed. Moist, warm air is optionally discharged to the surrounding area by an intermediate condenser/heat exchanger via an air outflow which is located above the door. The items which have been washed and are located in the chamber can be dried by the ambient air which is drawn in. However, one disadvantage of this procedure is that the water vapor which is expelled can dehumidify only partially during the brief period of time in the heat exchanger and a considerable amount of residual moisture is therefore blown into the room. This produces poor climatic conditions in the room in which the cleaning machine is installed, and this may lead to the precipitation of moisture, for example on cool outer walls, if the room is not adequately ventilated, and as a result promote mold formation. It is also possible for the condenser which is incorporated in the exhaust-air path of the cleaning machine itself to be contaminated and therefore for germs to be blown into the room. When the dishwasher is a table-top dishwasher, a further disadvantage arises in that the moist, warm air which is blown out from the machine at head height is blown into the face of the operator, this leading to extremely unfavorable working conditions from an ergonomic point of view.

DE 100 22 088 A1 describes a program-controlled dishwasher and a device for drying dishes. The program-controlled dishwasher which is disclosed in DE 100 22 088 A1 is provided with a device for drying dishes, with the dishes being heated in the washing container by recirculated warm washing liquid in the water-carrying washing cycles, and with the moisture in the washing container and on the items being washed being condensed in a closed circuit by means of a heat exchanger when washing liquid is pumped away in the “drying” program step. The device comprises a reservoir container which can be filled, during the “drying” program step, with cold fresh water and/or used, regenerated and flushing water from the appliance's own softening apparatus and which serves as a heat exchanger. Furthermore, an air-flow duct, which conducts process air out of the washing container for drying purposes in the closed circuit, is provided with a circulation fan. The air-flow duct is conducted past the outside of the reservoir container, with at least one side wall of the reservoir container being in the form of a duct wall, which forms a condensation surface, of the air-flow duct. Such a circulation condenser, which effectively supports the drying process, can be implemented in a structurally simple manner, particularly for a fully integrated appliance, and, in particular, requires little installation space in the appliance housing.

DE 100 2005 012 114 A1 discloses a dishwasher with a drying apparatus. In order to improve the drying process of a dishwasher, a first heat exchanger and a second heat exchanger are associated with the dishwasher. A flow duct with a heater and with a fan is associated with the first heat exchanger, and the second heat exchanger is arranged on at least one side wall of the washing container.

DE 198 35 722 A1 relates to a washing tub for a program-controlled dishwasher. The washing tub is formed, in particular, as a stainless steel washing tub for a program-controlled dishwasher with a fresh-water inflow and a water outflow. The outside walls are covered by a cladding. For the purpose of cooling the outside walls of the washing tub, the cladding is formed from a flat container which is matched to the outside walls of the washing tub, is made of a flexible material and can be filled with liquid. The cladding for the washing tub is composed particularly from a plurality of containers, with one container being provided for each of the outside walls, and the containers being connected to one another by a liquid line, and the liquid line being connected at the input end to the fresh-water inflow and at the output end to the water outflow.

### SUMMARY OF THE INVENTION

It is therefore an object of the present invention to provide a cleaning machine which dries the items which have been cleaned and cools them down again, with the working conditions and the climatic conditions in the room being considerably improved for the operator of the cleaning machine. Furthermore, the design of the cleaning machine provides very efficient and economical use of energy.

In an embodiment, a cleaning machine is provided that has a chamber for accommodating items to be cleaned. For its part, the chamber has a door and an outflow with a siphon bend. Also provided are devices for cleaning the items to be cleaned with heated washing water and also means for the thermal treatment of the items to be cleaned using hot final-washing water, which washing water and final-washing water is sprayed onto the soiled items to be cleaned by means of wash arms which are fixed in the washing chamber and can have one or more spray nozzles. Also provided are means for forcibly introducing feed air into the closed chamber of the cleaning machine, which is preferably a single-chamber dishwasher, after the thermal treatment. Finally, the cleaning machine proposed according to the invention has an exhaust-air line for discharging exhaust air from the closed chamber into the outflow when the door is closed. The exhaust air can preferably be introduced, in particular, in such a way that a volume of water, which functions as a trap, in the siphon bend is avoided in the process. The exhaust-air line has a fan and an exhaust air-valve.

The devices for forcibly introducing feed air into the closed chamber of the single-chamber cleaning machine preferably have a fan which draws in the air which is present in the cleaning machine and blows dry air from the surrounding area into the chamber. If the chamber door of the cleaning machine is designed to close in a sealing manner, it is possible, as an alternative or in addition, for the feed-air line to have a feed-air valve, in the case of which the air is preferably forcibly introduced into the chamber by a fan. Suitable feed air is, in particular, the air in the room in which the cleaning machine is installed.

The sterility of the feed air can additionally be improved by a microfilter. The feed-air valve is advantageously in the form of an automatically switching shut-off element which can either be controlled by a spring or weight, a diaphragm or a differential pressure, or be in the form of a non-return valve. The feed-air valve can also be in the form of a forcibly driven shut-off element.

Furthermore, as an alternative or in addition, the exhaust-air valve can also be an automatic shut-off element. This element can, for example, either be controlled by a spring or weight, a diaphragm or a differential pressure, or be in the form of a non-return valve. As an alternative, the exhaust-air valve can also be designed as a forcibly driven shut-off element.

The cleaning machine is designed in such a way that a program comprising at least the following method steps can be run through: the items to be cleaned are cleaned with heated hot water with the addition of additives; the items to be cleaned are subjected to final-washing with heated-up water with the addition of additives, and thermally treated; and the items which have been cleaned are forcibly cooled by feed air being forcibly introduced into the chamber and exhaust air, together with steam (water vapor) which is contained in the chamber, being drawn out of the chamber into the outflow.

In accordance with the solution proposed according to the invention, the program steps of washing with hot washing water and final-washing with hot final-washing water proceed within the chamber in a manner which is known per se. In the text which follows, the chamber is understood to be the washing chamber of a cleaning machine which accommodates the items to be cleaned and in which said items are treated. Following final-washing of the items to be cleaned by final-washing water which is introduced into the chamber, the steam (water vapor) is, according to the invention, forcibly drawn out of the chamber. At the same time, air flows into the chamber from the surrounding area, for example from the working room in which the cleaning machine is installed. Compared to the conditions in the chamber, the air which is drawn from the working room is cold and dry. When this air is introduced into the chamber, which is filled with steam (water vapor), of the cleaning machine, the steam in said chamber condenses, and the items which have been cleaned and are contained in the chamber cool down. The air which is supplied from the outside, for example room air, is discharged into the waste-water system of the building together with the residual steam through an exhaust-air connection piece which is connected to the waste-water system of the cleaning machine.

Shut-off elements, such as slides, flaps and valves, can be used in the lines from and to the chamber of the cleaning machine in order to influence the air flow in the chamber of the cleaning machine. The shut-off elements in the lines from and to the chamber can be in the form of, for example, non-return valves. Furthermore, the shut-off elements can also be in the form of flaps, slides or valves and can be used to hold back and therefore prevent odors escaping from the waste-water system during breaks in operation of the cleaning machine.

If the air stream introduced into the chamber is further maintained after the precipitation of the steam in said chamber, an additional, advantageous effect can be achieved in that the introduced air stream absorbs moisture from the surface of the items which have been cleaned and of the chamber and dries said items despite the chamber door being closed.

The solution proposed according to the invention advantageously ensures that drying of the items which have been cleaned takes place within the chamber when the door is closed and therefore no additional moisture is introduced into the working room in which the cleaning machine is installed. As a result, the working conditions for the operators and for the personnel in this room are considerably improved. The forced drawing of air into the chamber at the end of final-washing firstly causes the steam to precipitate and secondly accelerates cooling of the items which have been cleaned and are contained in the closed chamber. In the process, the solution proposed according to the invention can have the effect that the hot items which have been cleaned are cooled to a temperature at which they can be removed from the chamber by the operator, without the operator being burnt by the dishes. In addition, the steam (water vapor) which is present after final-washing is discharged downstream of the siphon into the waste-water system which is connected to the cleaning machine.

Furthermore, the solution proposed according to the invention can largely prevent water vapor (steam) escaping into the working area after the chamber door is opened and having an adverse effect on the working conditions for the personnel operating the cleaning machine.

Finally, the solution proposed according to the invention can prevent back-contamination of the items which have been cleaned. The room air which is drawn into the chamber is sterile compared to the water present in the water tank of the cleaning machine, so that the possibility of back-contamination by germs contained in the water is precluded. According to the solutions known to date, fresh water can additionally be sprayed into the chamber, and the associated additional water consumption can likewise be dispensed with in the solution proposed according to the invention since another medium, namely ambient air which is dry and cold compared to the conditions prevailing in the chamber, is used to precipitate the steam (water vapor) in the chamber.

In a further embodiment of the invention, the energy-saving cleaning machine can be designed with boundary walls for the washing chamber which are formed as double walls. Cold fresh water can be conducted through the cavity which is formed by the double walls. This water cools the walls which bound the washing chamber, and as a result the water vapor in the chamber can precipitate during, before or after the washing process and the amount of water vapor escaping from the washing chamber when the washing chamber door is opened at the end of the cleaning program can be considerably reduced. The water which flows through the cavity between the double walls heats up as it goes. The double walls form a heat exchanger which bears directly on the chamber. The preheated water can now be supplied to the boiler and can be used for final-washing for the next washing cycle. This procedure has a further positive effect on the energy balance of the cleaning machine proposed according to the invention.

By virtue of this embodiment of the solution proposed according to the invention, the heat of the water vapor can be utilized to preheat the final-washing water and energy from the washing process can be returned to the washing process by the abovementioned preheating of the boiler water for the final-washing cycle by means of the heat exchanger.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an embodiment of the energy-saving cleaning machine proposed according to the invention,

FIG. 2 shows a further embodiment of the energy-saving cleaning machine proposed according to the invention, in which at least one boundary wall of the washing chamber is in the form of a double wall,

FIG. 3 shows a schematic illustration of the chamber wall which is in the form of a double wall, and

FIG. 4 shows a design variant of the basic form described in FIG. 1.

### DETAILED DESCRIPTION

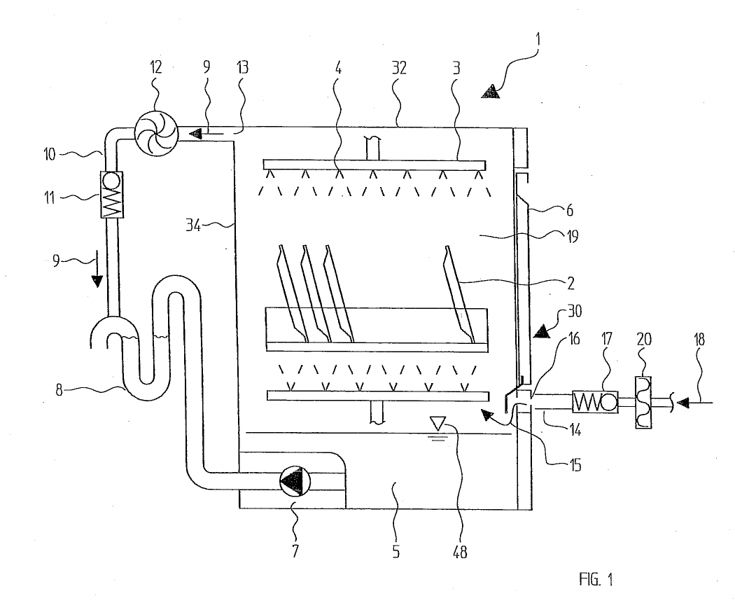

The illustration according to FIG. 1 shows a first embodiment of the cleaning machine proposed according to the invention.

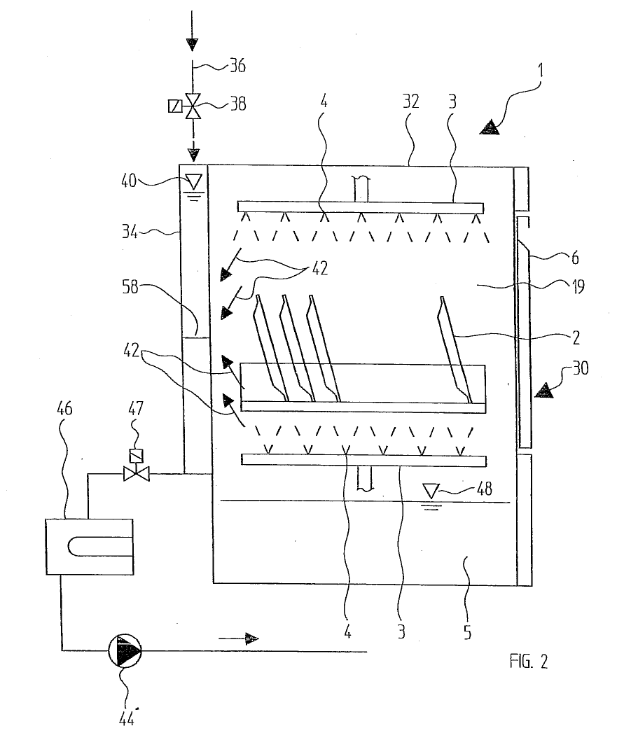

A cleaning machine 1, which is preferably a single-chamber dishwasher or the like, comprises a washing chamber 19 which is accessible via a chamber door 6 which is articulated on a hinge. The washing chamber 19 of the cleaning machine 1 according to FIG. 1 is bounded by a ceiling and side walls which are preferably in the form of double walls (compare the illustration according to FIG. 2). The items 2 which are to be cleaned or washed and are accommodated, for example, in one or more racks or the like, are cleaned in the interior of the washing chamber 19. A wash arm 3 which has a number of spray nozzles 4 is located on the ceiling of the cleaning machine 1. A further wash arm 3, which likewise has a number of spray nozzles 4, is located within the washing chamber 19, preferably below the rack for accommodating the items 2 to be cleaned. Cleaning liquid is sprayed onto the upper side of the items 2 to be cleaned via the wash arm 3 which is fixed to the ceiling of the washing chamber 19; cleaning liquid is sprayed from below onto the items 2 to be cleaned upward in the vertical direction via the spray nozzles 4 of the wash arm 3 which is arranged above a tank 5 in the base region of the washing chamber 19.

Both the wash arm 3 which is located on the chamber roof 32 and also the wash arm 3 which is arranged above the tank which accommodates the cleaning fluid are supplied with cleaning liquid via a circulation pump. In addition, a discharge pump 7 is located below the tank 5 in the base of the cleaning machine 1, said discharge pump conducting the liquor which has collected in the tank 5 to a waste-water line 8 with a siphon, depending on the degree of soiling.

The illustration according to FIG. 1 shows that an exhaust-air line 10 is located in the upper region of a chamber wall 34 in the rear region of the cleaning machine 1, exhaust air being drawn from the washing chamber 19 at an exhaust-air opening 13 via said exhaust-air line. To this end, an exhaust-air fan 12 is accommodated in the exhaust-air line 10, the exhaust air being drawn from the washing chamber 19 via the exhaust-air opening 13 by the exhaust-air fan, depending on how it is controlled. Upstream of its issuing point into the waste-water line, as seen in the direction of flow of the waste water, an exhaust-air valve which is in the form of a non-return valve is located, downstream of the siphon, in the exhaust-air line 10 in order to block odors from the waste-water system of the building. Reference symbol 9 indicates the direction of flow of the exhaust air in the exhaust-air line 10 when the exhaust-air fan 12 is switched on.

The embodiment of the cleaning machine 1 proposed according to the invention which can be operated in an energy-saving manner and is illustrated in FIG. 1 ensures that no water vapor escapes from the washing chamber 19 after the washing process when the door 6, which is illustrated in its closed position 30 in FIG. 1, is opened. The climatic conditions in the room in which the cleaning machine 1 proposed according to the invention is installed are accordingly not exposed to moist air when the door 6 is opened. Furthermore, when the wash pump is started, the solution proposed according to the invention prevents water vapor (steam) escaping to the outside as a result of the pressure surge caused by a sudden heating-up of the air in the washing chamber 19 and the associated expansion of the air in the washing chamber 19, since the water vapor is drawn out of the washing chamber 19 of the cleaning machine 1 illustrated in FIG. 1. Furthermore, drawing of the moist air which remains in the washing chamber 19 after the final-washing process can assist the drying process of the items 2 which have been cleaned or washed and furthermore cool the items 2 which have been cleaned in the washing chamber 19, so that said items can be removed from the washing chamber 19 of the cleaning machine 1 in the embodiment according to FIG. 1 following the final-washing process after a considerably shortened period of time elapses, without the risk of the operator being burnt.

During operation of the exhaust-air fan 12, the moist air which is contained in the washing chamber 19 is passed to the waste-water line downstream of the siphon, and contamination of the air in the room in which the cleaning machine 1 proposed according to the invention is installed is avoided. When exhaust air is drawn from the washing chamber 19 via the exhaust-air opening 13 during operation of the exhaust-air fan 12, room air flows into the washing chamber 19 via a feed-air line 16, which is located below the door 6, for continuity reasons. The air passes through the feed-air opening 16 in inflow direction 15, as indicated by the arrow in FIG. 1. A feed-air valve is connected upstream of the feed-air opening 16, said feed-air valve being in the form of, for example, a spring-loaded non-return valve which opens against a defined spring force only after the exhaust-air fan 12 is switched on and following the subsequent reduction in pressure in the washing chamber 19. A microfilter 20, by means of which room air 18 can once again be filtered before entering the washing chamber 19, can optionally be connected upstream of the feed-air valve 17. The feed-air valve 17 which is illustrated in the embodiment according to FIG. 1 can be arranged either directly at the feed-air opening 16 or else be arranged at a distance from the feed-air opening 16 via a feed-air line 14.

The solution proposed according to the invention—as illustrated in connection with FIG. 1—can prevent back-contamination, as would occur in the case of rinsing with cold water. Furthermore, the solution proposed according to the invention—as illustrated in connection with the embodiment illustrated in FIG. 1—does not blow warm, moist air into the room. It also prevents contamination of a condenser and, by means of this, germs being blown into the installation room of the cleaning machine. If the cleaning machine is installed, for example, at operator-head height, for example on a pedestal, the solution proposed according to the invention can accordingly prevent air being blown out at the head height of the operating personal, since said air is introduced into the waste-water line downstream of a siphon bend, which serves as a trap, at the rear end of the washing chamber 19, that is to say in the region of the chamber wall 34, through the exhaust-air opening 16 provided there.

The illustration according to FIG. 2 shows a further embodiment of the cleaning machine 1 proposed according to the invention which is suitable for extremely energy-saving operation.

Analogously to the embodiment of the cleaning machine according to FIG. 2, the embodiment of the cleaning machine 1 which is illustrated in FIG. 2 comprises a wash arm 3 which is accommodated on the chamber roof 32, whose spray nozzles 4 are directed downward in the direction of the items 2 which are to be cleaned or washed and are accommodated in the washing chamber 19. A further wash arm 3, whose spray nozzles 4 are oriented upward, is accommodated below the cleaning rack within the washing chamber 19, in which rack the items 2 to be cleaned are accommodated.

The tank 5, whose level is denoted by reference sign 48, is located below the wash arm 3. The illustration according to FIG. 2 shows that, when the door 30 is closed, the heat of the air which is located in the sealed washing chamber 19 is transferred to the chamber wall 34 which is in the form of a double wall in this embodiment. As indicated in the illustration according to FIG. 2, the chamber wall 34, which is in the form of a double wall, contains a liquid reservoir, for example cold water, which is conducted into the chamber wall 34, which is in the form of a double wall, via an inflow 36 with an inflow valve 38. Reference sign 40 denotes the filling level of the water, which has entered via the inflow valve 38, within the chamber of the chamber wall 34 which is in the form of a double wall. On the inside of the chamber wall 34 which is in the form of a double wall, heat is transferred 42 from the atmosphere contained in the washing chamber 19 to the water which has entered and is stored in the chamber wall 34 which is in the form of a double wall. The heated water is collected in a boiler 46 and can be reintroduced into the washing chamber 19 via a final-washing pump, which is identified by reference symbol 44, and a final-washing system (not illustrated), for example by means of the lower rotary arm 3, and can be used, for example after any further heating which may be required, to rinse the items 2 which have been cleaned or washed.

Reference symbol 47 denotes an outflow valve by means of which the water can optionally be held back in the heat exchanger if this is required by the process sequence.

Reference symbol 58 denotes the distance between the inner wall, which bounds the washing chamber 19, of the chamber wall 34, which is in the form of a double wall, and the outer wall of said chamber wall. The depth of the cavity, which depth is denoted by reference symbol 58, is of the order of magnitude of a few millimeters.

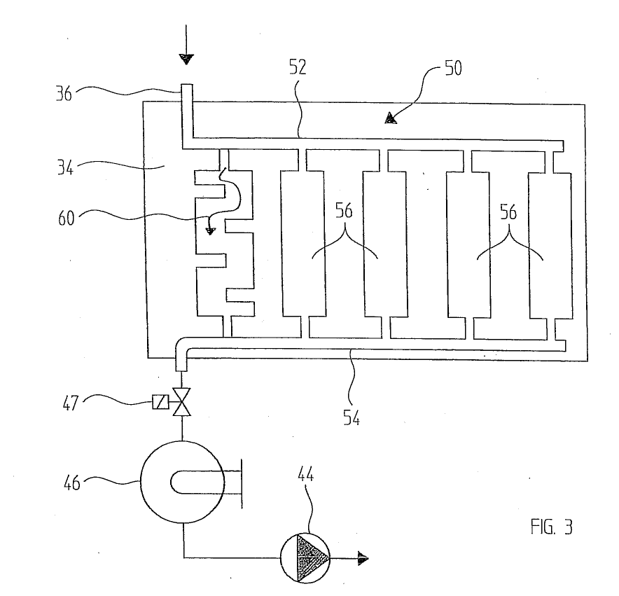

The illustration according to FIG. 3 shows a sectional view of the cavity of a chamber wall 34 which is designed as a double wall.

The view according to FIG. 3 shows that a heat-exchanger fluid, for example fresh water, enters the chamber wall 34, which is in the form of a double wall, via the inflow 36. The chamber wall 34, which is in the form of a double wall, contains the duct system 50 in which an inflow section 52 runs substantially in the horizontal direction and an outflow section 54 runs parallel but at a distance to said inflow section. Storage spaces 56 run between the inflow section 52 and the outflow section 54, which likewise runs in the horizontal direction, it being possible for said storage spaces to be rectangular and have an inflow and an outflow and be hydraulically connected to the inflow section 52 and the outflow section 54. Instead of the storage spaces 56 between the inflow section 52 and the outflow section 54 which are illustrated in FIG. 3, meandering storage spaces can also be used, said meandering storage spaces causing the heat-exchanger fluid to flow in a meandering fashion—indicated by reference sign 60—so that as large a region of the heated wall side, which faces the heated washing chamber 19, as possible is covered and accordingly a large amount of heat is transported 42, when the heat-exchanger fluid flows from the inflow section 52 in the direction of the outflow section 54.

Since the outlet ends of all the storage spaces 56 are connected to the outflow section 54, the heat-exchanger fluid, which is heated by transfer from the washing chamber 19 during passage from the inflow section 52 to the outflow section 54, flows to a boiler 46. The final-washing pump, which is denoted by reference symbol 44, is located downstream of the boiler 46.

After further heating which may be required, the heated water can be reintroduced into the washing chamber 19 by means of the final-washing pump 44 and a final-washing system (not illustrated) and be used, for example, to rinse the items 2 which have been cleaned or washed and are accommodated in said washing chamber.

The solution proposed according to the invention can utilize the energy contained in the heat-exchanger fluid, which has flowed through at least one boundary wall, which is in the form of a double wall, of the washing chamber 19, for preheating final-washing water, so that the heating energy required at the boiler 46 to reach the final heating temperature can be reduced. As a result, there is a considerable saving in energy in terms of the heating energy which is to be used to heat fresh water in the boiler 46 since at least some of the fresh water which is required for the subsequent final-washing cycle can be preheated in the manner proposed according to the invention. An outflow valve 47 for the heat-exchanger fluid 40 is connected upstream of the boiler 46 in this embodiment too.

Furthermore, the solution proposed according to the invention can condense the water vapor in the washing chamber 19 during or after the final-washing program and finally and ultimately considerably reduce the amount of water vapor escaping from the open chamber door 6 when said door is opened after the end of the cleaning program.

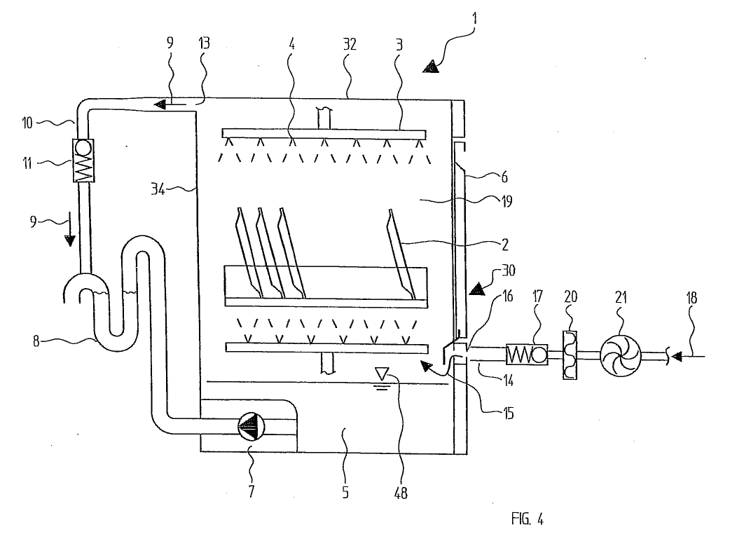

FIG. 4 shows a design variant of the embodiment of the cleaning machine variants proposed according to the invention and illustrated in FIG. 1.

In contrast to the embodiment according to FIG. 1, in which the exhaust-air fan 12 is arranged in the exhaust-air line 10 downstream of the exhaust-air opening 13, a fan 21 is arranged such that it is connected upstream of the feed-air valve 17 and the microfilter 20 in the embodiment according to FIG. 4. Dry and cold room air 18 is conveyed into the washing chamber 19 through the non-return valve 17, which is spring-loaded in the illustration according to FIG. 4, by means of the fan 21. For continuity reasons, a corresponding volume leaves said washing chamber via the exhaust-air line, which is denoted by reference symbol 10, and flows into the waste-water line 8 downstream of a siphon which contains a water trap reservoir.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A cleaning machine comprising:
a washing chamber for accommodating items to be cleaned;
at least one wash arm having a plurality of spray nozzles; and
a waste-water line into which waste water is pumped,
wherein exhaust air from the washing chamber is routed into the waste-water line downstream of a region which contains a water reservoir, and
wherein the washing chamber is bounded by at least one wall which stores a heat-exchanger fluid or through which heat-exchanger fluid flows.

2. The cleaning machine according to claim 1, wherein an exhaust-air fan is provided in the exhaust-air line downstream of an exhaust-air opening of the washing chamber.

3. The cleaning machine according to claim 2, wherein an exhaust-air valve upstream of the issuing point of the exhaust-air line into the waste-water line is provided downstream of the exhaust-air line in the exhaust-air line.

4. The cleaning machine according to claim 3, wherein the exhaust-air valve is a non-return valve.

5. The cleaning machine according to claim 1, wherein a feed-air opening is provided in the washing chamber via which feed-air opening ambient air subsequently flows when there is a negative pressure in the washing chamber.

6. The cleaning machine according to claim 1, wherein a feed-air valve is connected upstream of the feed-air opening.

7. The cleaning machine according to claim 1, wherein a microfilter is connected upstream of the feed-air opening.

8. The cleaning machine according to claim 1, wherein a feed-air fan is arranged upstream of the feed-air opening.

9. The cleaning machine according to claim 1, wherein the at least one chamber wall, which is in the form of a double wall, has an associated inflow that is controlled by an inflow valve.

10. The cleaning machine according to claim 1, wherein a plurality of storage spaces for accommodating heat-exchanger fluid are provided in the at least one chamber wall, which is in the form of a double wall.

11. The cleaning machine according to claim 1, wherein at least one inflow section and at least one outflow section run in the at least one chamber wall which is in the form of a double wall.

12. The cleaning machine according to claim 1, wherein an outflow valve, which is actuated in a process-dependent manner, is arranged downstream of the at least one outflow section.

13. The cleaning machine according to claim 1, wherein a boiler is arranged downstream of the at least one outflow section.

14. The cleaning machine according to claim 1, wherein water vapor which is contained in the washing chamber condenses on the chamber wall when the at least one chamber wall, which is in the form of a double wall, is filled with heat-exchanger fluid.
